(19) United States
(12) Patent Application Publication
(10) Pub. No.: US 2018/0183274 A1
(43) Pub. Date: Jun. 28, 2018

(54) WIRELESS ENERGY HARVESTING

(71) Applicant: Stamina Energy, LLC, Venice, CA (US)

(72) Inventors: DANIEL ANTHONY AUTEN, SAN JOSE, CA (US); CARLOS PIZARRO LEON, OVALLE (CL)

(21) Appl. No.: 15/853,228

(22) Filed: Dec. 22, 2017

Related U.S. Application Data
(60) Provisional application No. 62/438,553, filed on Dec. 23, 2016.

(51) Int. Cl. H02J 50/23; H02J 7/02; H04B 5/00; H01P 3/08; H02J 50/80

(52) U.S. Cl. CPC H02J 50/23; H02J 7/025; H02J 50/80; H01P 3/081; H04B 5/0031

(57) ABSTRACT

A device may operate using power generated by an energy harvesting system that generates power from, wireless signals. The energy harvesting system may collect wireless signals and convert the signals to energy. In one form factor, a device utilizing an energy harvesting system may operate without a battery and without a connection to a wired power source. In some cases, super capacitors may be used to store small harvested amounts of power for use by the device.

This application claims the benefit of U.S. Provisional Application No. 62/438,553, filed Dec. 23, 2016, for NEAR MEDUIM AND FAR FIELD COMMUNICATION ENERGY HARVESTING, which is incorporated in its entirety

### BACKGROUND OF THE INVENTION

### 1. Field of the Invention

The present invention relates generally to energy conversion, and more specifically to converting wireless frequencies to usable power.

### 2. Discussion of the Related Art

Many devices utilize electric energy for operation. These electronic devices require a power source such as a battery or a power outlet. While wireless charging methods have been developed, most wireless charger have very limited range.

### SUMMARY

In one embodiment, an energy harvesting system may include an antenna configured to receive radiated energy, wherein the antenna is a rectangular patch antenna comprising a first dimension selected as a function of a first target frequency, a rectifier circuit coupled to the antenna and configured to receive the radiated energy having been received and to generate a direct current output, and a load coupled to the rectifier circuit and configured to receive the direct current output having been generated.

A method of providing a system for energy harvesting is described. The method may include providing an antenna configured to receive radiated energy, wherein the antenna is a rectangular patch antenna comprising a first dimension selected as a function of a first target frequency, providing a rectifier circuit coupled to the antenna and configured to receive the radiated energy having been received and to generate a direct current output, and providing a load coupled to the rectifier circuit and configured to receive the direct current output having been generated.

A method of energy harvesting is described. The method may include using an antenna configured to receive radiated energy, wherein the antenna is a rectangular patch antenna comprising a first dimension selected as a function of a first target frequency, using a rectifier circuit coupled to the antenna and configured to receive the radiated energy having been received and to generate a direct current output, and using a load coupled to the rectifier circuit and configured to receive the direct current output having been generated.

Some examples of the energy harvesting system described above may also include a matching circuit interposed between the antenna and the rectifier and configured to impedance match the antenna to the rectifier circuit.

Some examples of the energy harvesting system described above may also include a voltage multiplier interposed between the antenna and the rectifier and configured to increase the voltage of the radiated energy.

In some examples of the energy harvesting system described above, said antenna configured to receive radiated energy, wherein said antenna may be said rectangular patch antenna comprising a second dimension selected as a function of a second target frequency. In some examples of the energy harvesting system described above, said antenna configured to receive radiated energy, wherein said antenna may be said rectangular patch antenna comprising feed point comprising a feed point location selected as a function of said first target frequency and said target frequency.

Some examples of the energy harvesting system described above may also include a printed circuit board. In some examples of the energy harvesting system described above, said antenna configured to receive radiated energy, wherein said antenna may be a patch antenna juxtaposed with the printed circuit board.

Some examples of the energy harvesting system described above may also include a ground plane juxtaposed with said printed circuit board opposite from said antenna, whereby said printed circuit board may be interposed between said antenna and said ground plane.

In some examples of the energy harvesting system described above, said load comprising an energy storage device configured to store energy from said direct current output.

### BRIEF DESCRIPTION OF THE DRAWINGS

FIG. 1 illustrates an example of an energy-harvesting system that supports harvesting wireless frequencies and converting them, to usable power in accordance with aspects of the present disclosure.

FIG. 2 illustrates an. example of an energy-harvesting system with multiple antennas that supports harvesting wireless frequencies and converting them to usable power in accordance with aspects of the present disclosure.

FIG. 3 illustrates an example of an energy-harvesting system with a wireless sensor network (WSN) that supports harvesting wireless frequencies and converting them to usable power in accordance with aspects of the present disclosure.

FIG. 4 illustrates an example of a patch antenna that supports harvesting wireless frequencies and converting them to usable power in accordance with aspects of the present disclosure.

FIG. 5 illustrates an example of a patch antenna with a feed point that supports harvesting wireless frequencies and converting them to usable power in accordance with aspects of the present disclosure.

FIG. 6 illustrates an example of a printed circuit board (PCB) that supports harvesting wireless frequencies and converting them to usable power in accordance with aspects of the present disclosure.

FIG. 7 illustrates an example of a rectifier that supports harvesting wireless frequencies and converting them to usable power in accordance with aspects of the present disclosure.

FIG. 8 illustrates an example of a voltage double circuit that supports harvesting wireless frequencies and converting them to usable power in accordance with aspects of the present disclosure.

FIG. 9 illustrates an example of simulation results of a circuit that supports harvesting wireless frequencies and converting them, to usable power in accordance with aspects of the present disclosure.

FIG. 10 illustrates an example of a return loss chart of a circuit that supports harvesting wireless frequencies and converting them to usable power in accordance with aspects of the present disclosure.

FIG. 11 illustrates an example of a Smith chart of a circuit that supports harvesting wireless frequencies and converting them to usable power in accordance with aspects of the present disclosure.

FIGS. 12A and 12B illustrate an example of a forward voltage drop at less than 1 mA in accordance with aspects of the present disclosure.

FIGS. 13A and 13B illustrate an example of a forward voltage drop at greater than 1 mA, in accordance with aspects of the present disclosure.

FIG. 14 illustrates an example of a process performed by a manufacturing system to provide a system for harvesting wireless frequencies and converting them to usable power in accordance with aspects of the present disclosure.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

A device may operate using power generated by an energy harvesting system that generates power from wireless signals outside the spectrum used for Near field communication (NFC) signals. NFC generally refers to using electromagnetic induction between two loop antennas on devices to exchange information, operating within the globally available unlicensed radio frequency ISM band of 13.56 MHz on ISO/IEC 18000-3 air interface at rates ranging from. 106 to 424 kbit/s. The system may harvest, instead, Wi-Fi (2.4 GHz or 5 GHz)or Bluetooth (2.4 to 2,485 GHz) frequencies, for example. The energy-harvesting system may collect wireless signals and convert the signals to energy. In one form factor, a device utilizing an energy harvesting system may operate without a battery and without a connection to a wired power source.

In some cases, super capacitors may be used to store harvested amounts of power over time for use by the device. The energy that has been harvested can accumulate for either an automatic action by the device, such as a Global Positioning System (GPS) signal activation, or for a user defined action, such as shaking the card or pressing a button on an electronic card to activate a BLE chip for pairing with an external device.

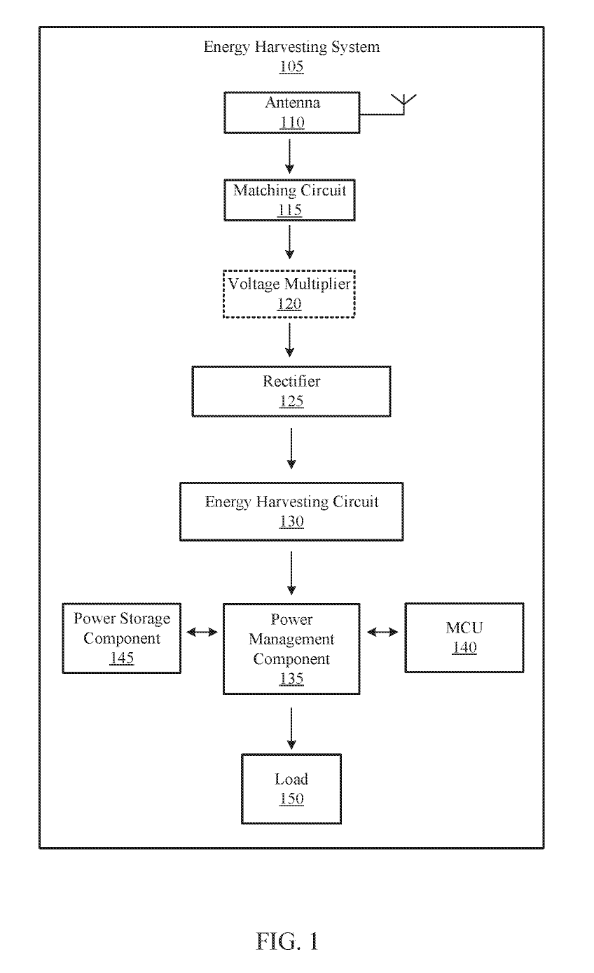

FIG. 1 illustrates an example of an energy harvesting system 105 that supports harvesting wireless frequencies and converting them to usable power in accordance with aspects of the present disclosure.

An energy harvesting system 105 may collect ambient energy from electromagnetic signals in the surrounding environment. Ambient energy may comprise cellular frequency (e.g. 1900 MHz) and/or WiFi frequency (e.g. 2.4 GHz and 5 GHz). In some embodiments, the energy harvesting system 105 may be configure to harvest energy from high (3-30 MHz), very high (30-300 MHz), and/or ultrahigh frequency (300-3000 MHz) signals. In some embodiments, the energy harvesting system 105 may be configured for 3 to 30 Hz, 10̂-3 MHz, 3×10̂ Hz, and/or 10̂20 Hz. The energy harvesting system 105 may collect energy at an antenna 110, perform, impedance matching or filtering, rectify the energy at a rectifier 125, and store the energy or use the energy for operation.

The energy harvesting system 105 may perform medium to long distance power harvesting using Far Field Communication Energy Harvesting (FFCEH) or Medium Field Communication Energy Harvesting (MCEH). The range of collection may be valuable for use in mobile devices so that a person may be “on the go” (e.g., simply walking down a normal sidewalk) and be harvesting a significant amount of energy. The energy harvesting system 105 may harvest a single frequency or multiple frequencies at the same time.

For example, frequencies used for cellular or Wi-fi communications may be harvested. One common frequency for use in cellular communications is 1900 MHz. Wi-Fi communications may use 2.4 GHz or 5 GHz frequencies. Other frequencies, including non-cellular or non-Wi-Fi frequencies may also be used.

In some examples, the energy harvesting system 105 may be located on a circuit board, and may contain other electronic components in addition to the electronic components described herein. The energy harvesting system 105 can be increased or decreased in size and may be optimized for energy harvesting, collection, and transfer. The energy harvesting system 105 may also be used to decrease energy use on a device with another primary power source.

In some cases, an energy harvesting system 105 with larger antennas 110 may be used to harvest more energy. In some embodiments, the energy harvesting system 105 uses a chip on die, or chip on board, or chip in die form. In one embodiment, the energy harvesting system 105 is designed for use in small and thin devices, such as an electronic card.

In some cases, an energy harvesting system 105 may include a Bluetooth low-energy (BLE) or GPS system. In one example, once the energy harvesting system 105 has collected enough energy, a card can emit a Bluetooth signal (e.g., from a BLE chip) to connect to other devices or be paired for a certain amount of time. In another example, once there is enough energy harvested from various frequencies, a GPS chip may activate for a certain amount of time. This may allow luggage or packages to be tracked by the without a big device or battery.

In some cases, an energy harvesting system 105 may be connected to an EMV or Near Field Communication (NFC) component. Devices that utilize the energy harvesting system 105 may include electronic cards, small electronic devices, and other electronic devices such as those used by online retailers, card issuers, device creators, individuals, security companies, and banks.

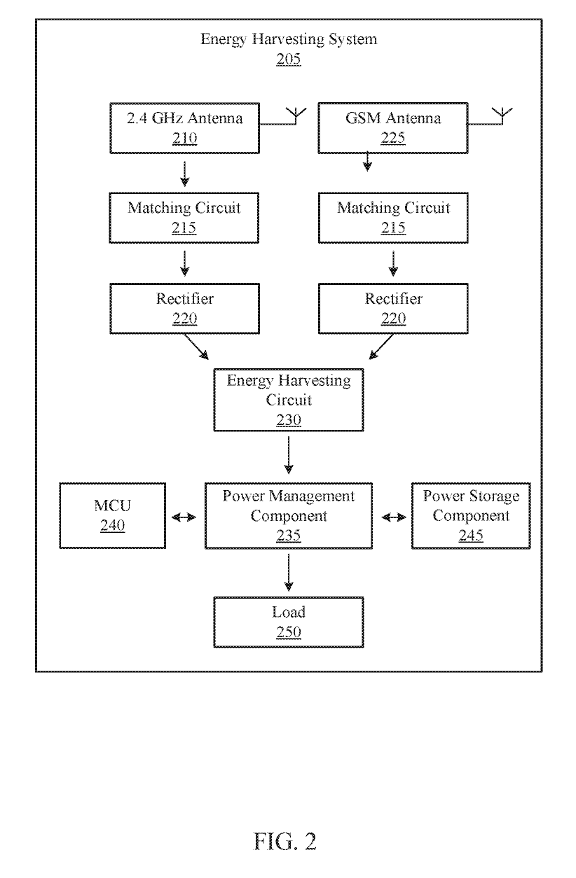

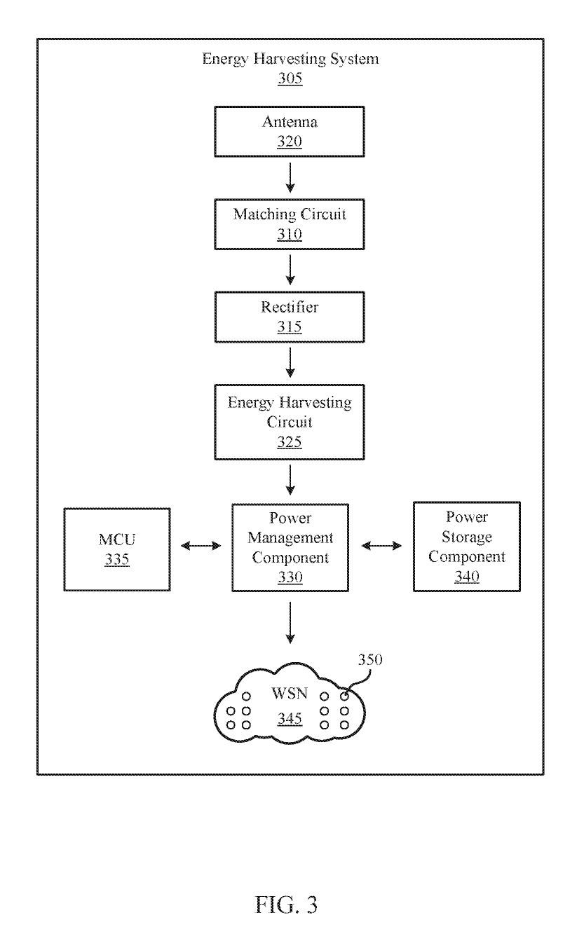

Energy harvesting system 105 may be an example of, or incorporate aspects of, energy harvesting system 205 and 305 as described with reference to FIGS. 2 and 3. In some examples, energy harvesting system 105 may include antenna 110, matching circuit 115, voltage multiplier 120, rectifier 125, energy harvesting circuit 130, power management component 135, microcontroller unit (MCU) 140, power storage component 145, and load 150.

Antenna 110 may be an example of, or incorporate aspects of, antenna 320, 405, 505, and 610 as described with reference to FIGS. 3, 4, 5, and 6. Antenna 110 may be configured to receive radiated energy.

In one embodiment, the antenna 110 is a rectangular patch antenna comprising a first dimension selected as a function of a first target frequency. In some cases, the antenna 110 may comprise a second dimension selected as a function of a second target frequency. In some cases, the antenna 110 comprises a feed point comprising a feed point location selected as a function of the first target frequency and the target frequency. In some cases, the antenna 110 is a patch antenna juxtaposed with a printed circuit board. In some embodiments, the antenna 110 may comprise a patch antenna of a different shape such as square, circle, and oval.

Different antenna 110 shapes may be used to harvest different frequencies. Generic shapes may also be used. In some cases, the energy harvesting system 105 may use multiple or combined antennas 110 to harvest multiple frequencies.

Matching circuit 115 may be an example of, or incorporate aspects of, matching circuit 215, 310, 625, and 720 as described with reference to FIGS. 2, 3, 6, and 7. Matching circuit 115 may be an example of a component interposed between the antenna 110 and the rectifier 125 and configured to impedance match the antenna 110 to the rectifier 125. In some cases, the matching circuit 115 may include an RF impedance matching circuit 115, and RF filter circuit, or another component capable of tuning the antenna 110 to the correct frequency for harvesting.

In some examples, a voltage multiplier 120 may be optionally interposed between the antenna 110 and the rectifier 125 and may be configured to increase the voltage of the radiated energy.

Rectifier 125 may be an example of, or incorporate aspects of, rectifier 220, 315, and 705 as described with reference to FIGS. 2, 3, and 7. Rectifier 125 may be coupled to the antenna 110 and may be configured to receive the radiated energy having been received at the antenna 110 and generate a direct current (DC) output.

The rectifier 125 may be a small electronic component that is attached to the antenna 110 and converts energy into the right format for the energy harvesting circuit 130. For example, the rectifier 125 may convert AC power to directional DC power. The rectifier 125 may include one or more inductors, capacitors, diodes, and in some cases, transistors. In some cases, the combination of the antenna 110, matching circuit 115, and rectifier 125 may be known collectively as a “rectenna.”

Energy harvesting circuit 130 may be an example of, or incorporate aspects of, energy harvesting circuit 230 and 325 as described with reference to FIGS. 2 and 3. The energy harvesting circuit 130 enables the harvesting of energy from one or more frequencies or electromagnetic radiation. In some cases, the energy does not flood the circuit, but comes in smaller doses that eventually fill the power storage component 145. That is, “drips” of energy may eventually fill a “bucket” until it is full or has enough energy to supply a device to perform a function. The energy harvesting circuit 130 may include an MCU 140.

Power management component 135 may be an example of, or incorporate aspects of, power management component 235 and 330 as described with reference to FIGS. 2 and 3. The power management component 135 may direct energy to and between other components such as an MCU 140, a power storage component 145, or a load 150. In some embodiments, the power management component 135 and/or MCU 140 may determine when to supply the energy stored in the power storage component 145 to the load 150. For example, the MCU 140 may periodically supply energy from the power storage component 145 to a load comprising a GPS sensor to record the GPS location of the energy harvesting system 105. In another example, the energy harvesting system 105 may comprise a user input (e.g. button) that allows the user to activate the load 150.

MCU 140 may be an example of, or incorporate aspects of, MCU 240 and 335 as described with reference to FIGS. 2 and 3. In some examples, the MCU 140 may be a small computer on a single integrated circuit. In some embodiments, the MCU 140 is configured to control a devices that uses the stored energy (e.g. load) and/or control when stored energy is supplied to such device. In some embodiments, the MCU 140 may be optional or absent in the energy harvesting system 105 and the function of the MCU 140 described herein may be carried out by a separate device that uses the harvested energy. For example, the energy harvesting system 105 may functionally be a passive power supply (e.g. battery) to the load device.

Power storage component 145 may be an example of, or incorporate aspects of, power storage component 245 and 340 as described with reference to FIGS. 2 and 3. The power storage component 145 may be a battery, a super-capacitor, or another suitable power storage device for storage and later of energy harvested by the energy harvesting system 105.

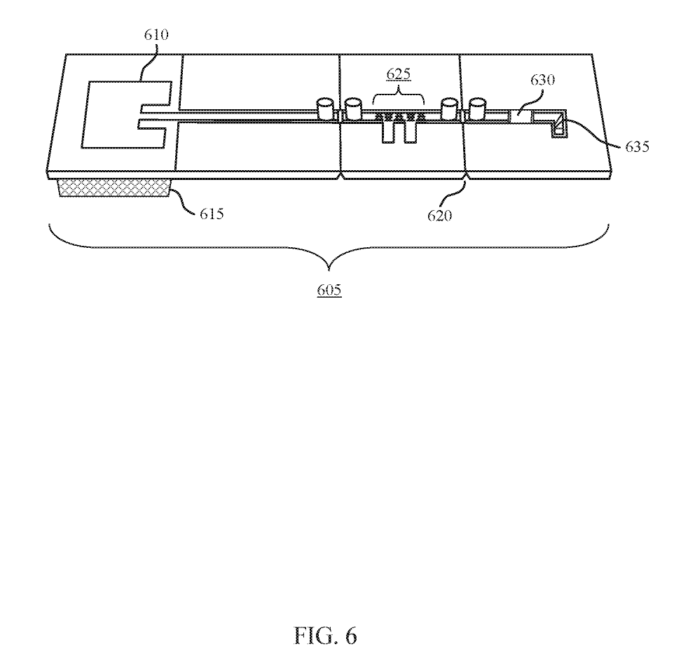

Load 150 may be an example of, or incorporate aspects of, load 250 and 635 as described with reference to FIGS. 2 and 6. For example, load 150 may be an electronic card or a wireless sensor network (WSN). Load 150 may be coupled to the rectifier 125 circuit and configured to receive the direct current output having been generated.

The load 150 may be an electrical component or portion of a circuit that consumes electric power (as opposed to a power source, such as a battery or generator, which produces power). The load 150 may also represent the power consumed by the circuit. In some cases, a load 150 may represent a device connected to a signal source, regardless of whether it consumes power. If an electric circuit has an output port, (i.e., a pair of terminals that produces an electrical signal), the load 150 may be the circuit connected to this terminal (or its input impedance). In some embodiments, the load 150 may comprise a sensor (e.g. GPS sensor) or a transceiver (e.g. BLE, NFC) that uses the energy harvested by the energy harvesting system 105 to collect data and/or communicate with another device.

FIG. 2 illustrates an example of an energy-harvesting system 205 with multiple antennas that supports harvesting wireless frequencies and converting them to usable power in accordance with aspects of the present disclosure.

Energy harvesting system 205 may be an example of, or incorporate aspects of, energy harvesting system 105 and 305 as described with reference to FIGS. 1 and 3.

In some examples, energy harvesting system 205 may include 2.4 GHz antenna 210, matching circuit 215, rectifier 220, GSM antenna 225, energy harvesting circuit 230, power management component 235, MCU 240, power storage component 245, and load 250.

2.4 GHz antenna 210 and GSM antenna 225 may be examples of, or incorporate aspects of, antenna 110, 320, 405, 505, and 610 as described with reference to FIGS. 1, 3, 4, 5, and 6. 2.4 GHz antenna 210 and GSM antenna 225 are used as illustrative examples and any other suitable antennas may also be used to capture other frequencies or signals.

In some cases, the 2.4 GHz antenna 210 may collect wireless signals emitted by Wi-Fi devices. A 2.4 GHz antenna 210 may be an example of an antenna used by an energy harvesting system 205, but antennas optimized for other frequencies may also be used.

In some cases, the GSM antenna 225 may collect significant energy at frequencies between 380 MHz and 1900 MHz and at ranges up to few kilometers. The GSM antenna 225 may be an example of an antenna used by an energy harvesting system 205.

Matching circuits 215 may be an example of, or incorporate aspects of, matching circuit 115, 310, 625, and 720 as described with reference to FIGS. 1, 3, 6, and

Rectifiers 220 may be an example of, or incorporate aspects of, rectifier 125, 315, and 705 as described with reference to FIGS. 1, 3, and 7.

Energy harvesting circuit 230 may be an example of, or incorporate aspects of, energy harvesting circuit 130 and 325 as described with reference to FIGS. 1 and 3.

Power management component 235 may be an example of, or incorporate aspects of, power management component 135 and 330 as described with reference to FIGS. 1 and 3.

MCU 240 may be an example of, or incorporate aspects of, MCU 140 and 335 as described with reference to FIGS. 1 and 3. In some embodiments, MCU 240 may be optional or absent in the energy harvesting system 205.

Power storage component 245 may be an example of, or incorporate aspects of, power storage component 145 and 340 as described with reference to FIGS. 1 and 3.

Load 250 may be an example of, or incorporate aspects of, load 150 and 635 as described with reference to FIGS. 1 and 6.

FIG. 3 illustrates an example of an energy-harvesting system 305 with a wireless sensor network (WSN) 345 that supports harvesting wireless frequencies and converting them to usable power in accordance with aspects of the present disclosure.

Energy harvesting system 305 may be an example of, or incorporate aspects of, energy harvesting system 105 and 205 as described with reference to FIGS. 1 and 2. In some examples, energy harvesting system 305 may include matching circuit 310, rectifier 315, antenna 320, energy harvesting circuit 325, power management component 330, MCU 335, power storage component 340, and WSN 345.

Antenna 320 may be an example of, or incorporate aspects of, antenna 110, 405, 505, and 610 as described with reference to FIGS. 1, 4, 5, and 6. Matching circuit 310 may be an example of, or incorporate aspects of, matching circuit 115, 215, 625, and 720 as described with reference to FIGS. 1, 2, 6, and 7. Rectifier 315 may be an example of, or incorporate aspects of, rectifier 125, 220, and 705 as described with reference to FIGS. 1, 2, and 7.

Energy harvesting circuit 325 may be an example of, or incorporate aspects of, energy harvesting circuit 130 and 230 as described with reference to FIGS. 1 and 2. Power management component 330 may be an example of, or incorporate aspects of, power management component 135 and 235 as described with reference to FIGS. 1 and 2.

MCU 335 may be an example of, or incorporate aspects of, MCU 140 and 240 as described with reference to FIGS. 1 and 2. Power storage component 340 may be an example of, or incorporate aspects of, power storage component 145 and 245 as described with reference to FIGS. 1 and 2. In some embodiments, MCU 335 may be optional or absent in the energy harvesting system 305.

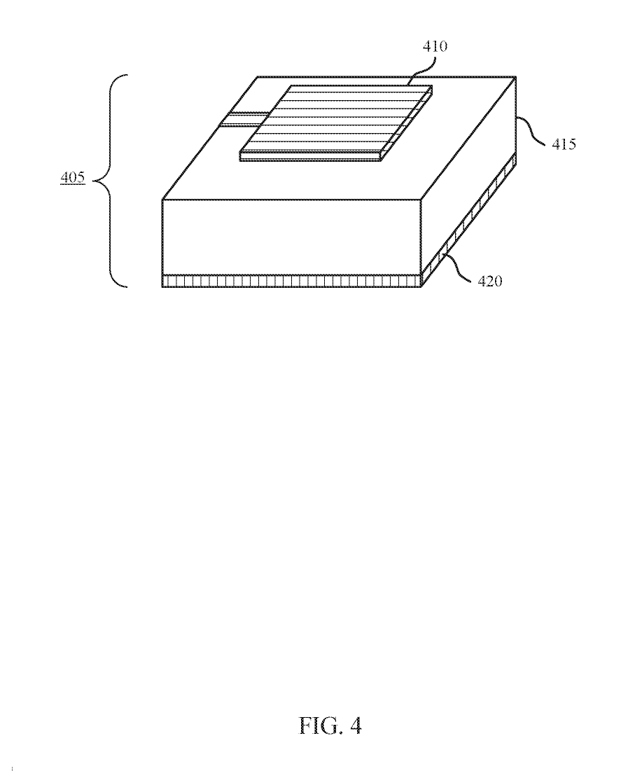

FIG. 4 illustrates an example of a patch antenna 405 that supports harvesting wireless frequencies and converting them to usable power in accordance with aspects of the present disclosure.

In some cases, an energy harvesting system may utilize a microstrip patch antenna 405. The antenna 405 may radiate at multiple frequencies (e.g., at two frequency ranges including 1.8-1.85 GHz and 2.4-2.45 GHz). Some antennas 405 may incorporate more frequencies and some may have less. In some embodiments a microstrip antenna comprises of a patch of metal foil of various shapes (e,g, patch ) on the surface of a PCB, with a metal foil ground plane on the other side of the board. In some cases, a microstrip antennas comprises of multiple patches in a two-dimensional array. The antenna may be connected to a transmitter or receiver through foil microstrip transmission lines. The radio frequency current received between the antenna and ground plane.

In one example, the size of the antenna 405 may be 60 mm by 60 mm, including the ground 420. Other sizes are also possible. In some cases, a rectangle patch antenna 405 may be fed by using a coaxial line. This coaxial probe may be configured for matching the antenna 405 to a 50 Ohm frequency.

Patch antenna 405 may be an example of, or incorporate aspects of, antenna 110, 320, 505, and 610 as described with reference to FIGS. 1, 3, 5, and 6. In some examples, patch antenna 405 may include patch 410, dielectric 415, and ground 420.

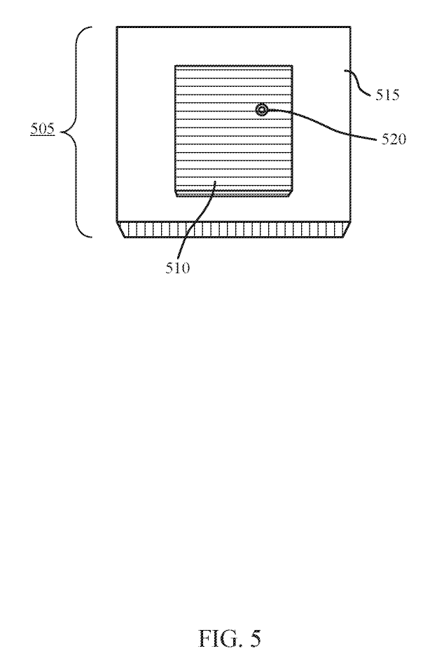

Patch 410 may be an electrically conductive material, and may be an example of, or incorporate aspects of, patch 510 as described with reference to FIG. 5.

Dielectric 415 may be an example of, or incorporate aspects of, dielectric 515 as described with reference to FIG. 5. A dielectric material is an electrical insulator that can be polarized by an applied electric field. When a dielectric is placed in an electric field, electric charges do not flow through the material as they do in an electrical conductor but only slightly shift from their average equilibrium positions causing dielectric polarization. Because of dielectric polarization, positive charges are displaced in the direction of the field and negative charges shift in the opposite direction.

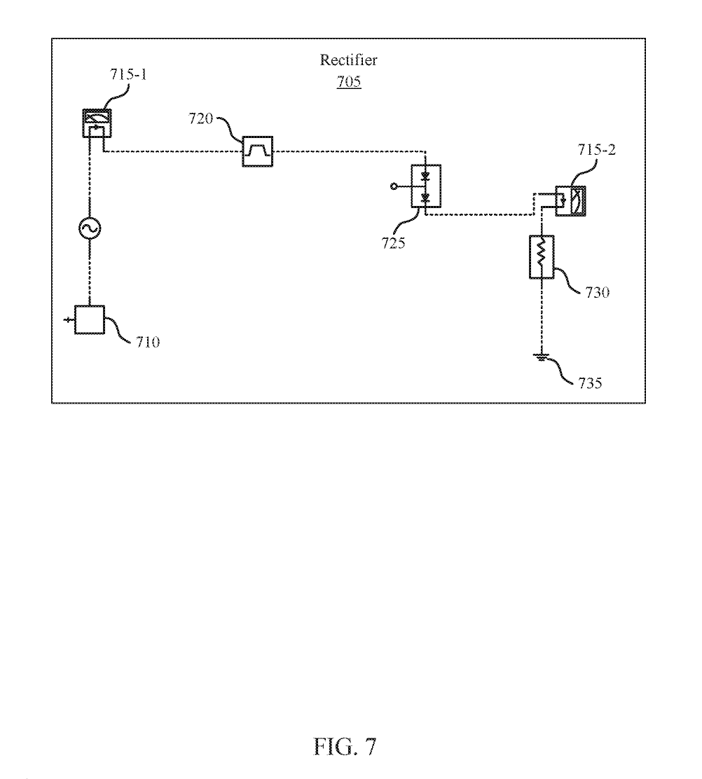

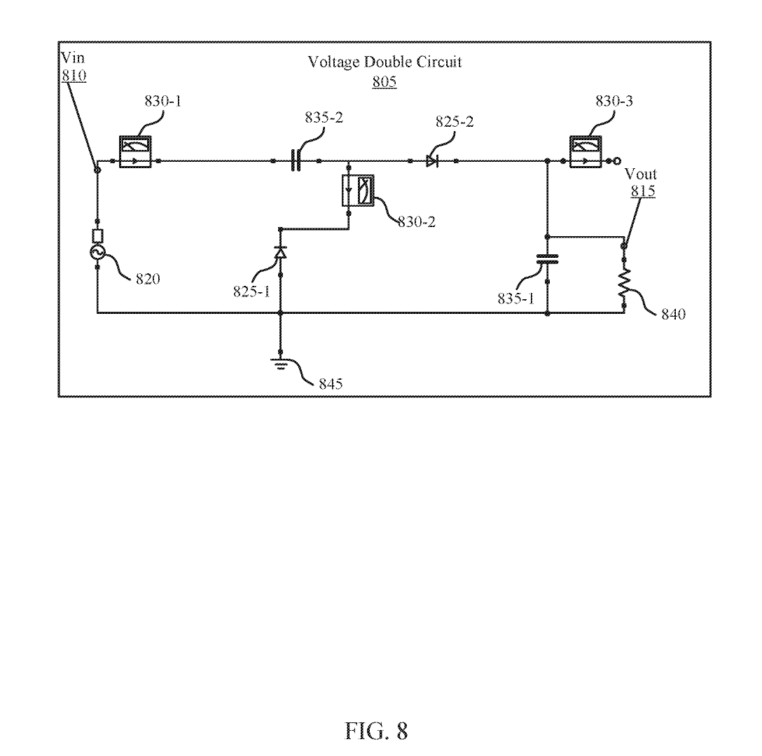

Ground 420 may be an example of, or incorporate aspects of, ground 735 and 845 as described with reference to FIGS. 7 and 8. Ground 420 may be an example of a component plane juxtaposed with the printed circuit board opposite from the antenna 405, whereby a printed circuit board is interposed between the antenna 405 and the ground plane.

In one embodiment, antenna 405 may be designed according to the following parameters: the patch length may be 37.1 mm, patch breadth may be 27.1 mm, the substrate may be a FR4 rated substrate of size 60 mm×60 mm, and the ground plane may be 60 mm×60 mm. The length of the patch is measured along the direction of the microstrips (left to right in the FIG.). The breadth of the patch is measured across the microstrips (top to bottom in the FIG.).

FIG. 5 illustrates an example of a patch 510 antenna 505 with a feed point 520 that supports harvesting wireless frequencies and converting them to usable power in accordance with aspects of the present disclosure.

In some cases, the antenna is configured to be excited at a point such that the waves are 90° out of phase. This results in one set of traveling wave along the x-direction (shorter side) resonating at, for example, 2.4 GHz, and another set of traveling wave along the y-direction (longer side) resonating at, for example, 1.8 GHz. By using coaxial feeding, the position of the feed point 520 may be adjusted so that waves can be excited in multiple different directions simultaneously and match the antenna 505 for maximum return loss.

In one embodiment, the patch 510 may have a length (along x-axis) of 37.1 mm and a breadth (along y-axis) of 27.1 mm on a substrate 515 of size 60 mm×60 mm and a ground plane of size 60 mm×60 mm. The feed point 520 may be located at a point 7.2 mm from the right edge and 6.6 mm below the top edge of the antenna 510. These dimensions are configured to harvest 1.8 GHz and 2.4 GHz radio frequencies by resonating at 2.4 GHz in the x-direction and at 1.8 GHz in the y-direction. Generally, the dimensions of the antenna 505 may be selected based on the target frequency/frequencies that the antenna is configured to harvest.

Antenna 505 may be an example of, or incorporate aspects of, antenna 110, 320, 405, and 610 as described with reference to FIGS. 1, 3, 4, and 6. In some examples, antenna 505 may include patch 510, dielectric 515, and feed point 520. Patch 510 may be an example of, or incorporate aspects of, patch 410 as described with reference to FIG. 4. Dielectric 515 may be an example of, or incorporate aspects of, dielectric 415 as described with reference to FIG. 4.

FIG. 6 illustrates an example of a printed circuit board (PCB) 605 that supports harvesting wireless frequencies and converting them to usable power in accordance with aspects of the present disclosure.

A PCB 605 assembly or similar printing assembly may be used for making boards and circuit assemblies for energy harvesting system. In one example, the energy harvesting system may use a PCB 605 (e.g., a PCB 605 with an FR4 grade designation) to implement the SMD component such as transmission line to reduce the soldering loss (around 0.2 dB). The connections are made and traces input using a power loss prevention scheme.

In some examples, PCB 605 may include antenna 610, rubber standoff 615, v-cuts 620, matching circuit 625, diode 630, and load 635.

Antenna 610 may be an example of, or incorporate aspects of, antenna 110, 320, 405, and 505 as described with reference to FIGS. 1, 3, 4, and 5. The antenna 610 on a PCB 605 could be printed using copper or other metal (depending on the signal type, expected range of collection, and other aspects).

Matching circuit 625 may be an example of, or incorporate aspects of, matching circuit 115, 215, 310, and 720 as described with reference to FIGS. 1, 2, 3, and 7. The matching circuit 625 may be designed to get the maximum power transferred from the receiver to load 635 so that more power can be harvested in a smaller space.

Diode 630 may be an example of, or incorporate aspects of, diode 725 and 825 as described with reference to FIGS. 7 and 8. In some examples, the diode 630 has very low forward voltage drop and a frequency range of 6 GHz. In some examples, the diode 630 may be a Schottky diode 630, such as a high frequency Schottky diode 630 with low forward dropping voltage and high switching speed. The diode 630 may be customized through directional connection pairing and cross-sectional underlap. In some embodiments, the diode 630 may comprise a HSMS-285B noncustomer diode which is later customized. The diode may comprise a maximum forward voltage of 150 mV at 0.1 mA and 250 mV at 1 mA, and a typical capacitance of 0.30 pF at −0.5V to −1.0V.

Load 635 may be an example of, or incorporate aspects of, load 150 and 250 as described with reference to FIGS. 1 and 2.

FIG. 7 illustrates an example of a rectifier 705 that supports harvesting wireless frequencies and converting them to usable power in accordance with aspects of the present disclosure.

Rectifier 705 may take power in one form and convert it to power in another form. For example, rectifier 705 may receive alternating current (AC) power for an antenna and convert it to direct current (DC) power for an energy harvesting circuit. Rectifier 705 may be an example of, or incorporate aspects of, rectifier 125, 220, and 315 as described with reference to FIGS. 1, 2, and 3.

In some examples, rectifier 705 may include source 710, probes 715 (715-1 and 715-2), matching circuit 720, diode 725, terminal 730, and ground 735.

Source 710 may be an example of, or incorporate aspects of, source 820 as described with reference to FIG. 8. Probe 715 may be an example of, or incorporate aspects of, probe 830 as described with reference to FIG. 8.

Matching circuit 720 may be an example of, or incorporate aspects of, matching circuit 115, 215, 310, and 625 as described with reference to FIGS. 1, 2, 3, and 6. Diode 725 may be an example of, or incorporate aspects of, diode 630 and 825 as described with reference to FIGS. 6 and 8. Ground 735 may be an example of, or incorporate aspects of, ground 420 and 845 as described with reference to FIGS. 4 and 8.

FIG. 8 illustrates an example of a voltage double circuit 805 that supports harvesting wireless frequencies and converting them to usable power in accordance with aspects of the present disclosure.

A voltage double circuit 805 may be an example of a voltage multiplier. A voltage multiplier may be used to increase the output 815 voltage of an energy harvesting system. In some cases, the voltage multiplier is separate from the rectifier. In some cases, the energy harvesting system has a single circuit that functions as a rectifier and a voltage a multiplier resulting in a smaller device size.

In some cases, an energy harvesting system may use a minimum output 815 voltage. For example, a router may emit Wi-Fi signals that are received at a particular range with an input 810 power at 100 mW. In this case, a rectifier circuit may not be sufficient to generate the appropriate output 815 voltage. Thus, an energy-harvesting system may use a circuit to increase the voltage.

As illustrated, the voltage double circuit 805 may comprise a two-circuit diode 825 and a ceramic capacitor 835. In some examples, voltage double circuit 805 may include input 810, output 815, source 820 (e.g., impedance=50 Ohm), diodes 825 (825-1 and 825-2, e.g. Is=3e−6 A, CjO=180 fF), probes 830 (830-1, 830-2, and 830-3), capacitors 835 (835-1 and 835-2, e.g. 10 pF), resistor 840 (e.g. 100 kOhm), and ground 845.

Source 820 may be an example of, or incorporate aspects of, source 710 as described with reference to FIG. 7. Diode 825 may be an example of, or incorporate aspects of, diode 630 and 725 as described with reference to FIGS. 6 and 7. Probes 830 may be an example of, or incorporate aspects of, probe 715 as described with reference to FIG. 7. Ground 8 45 may be an example of, or incorporate aspects of, ground 420 and 735 as described with reference to FIGS. 4 and 7.

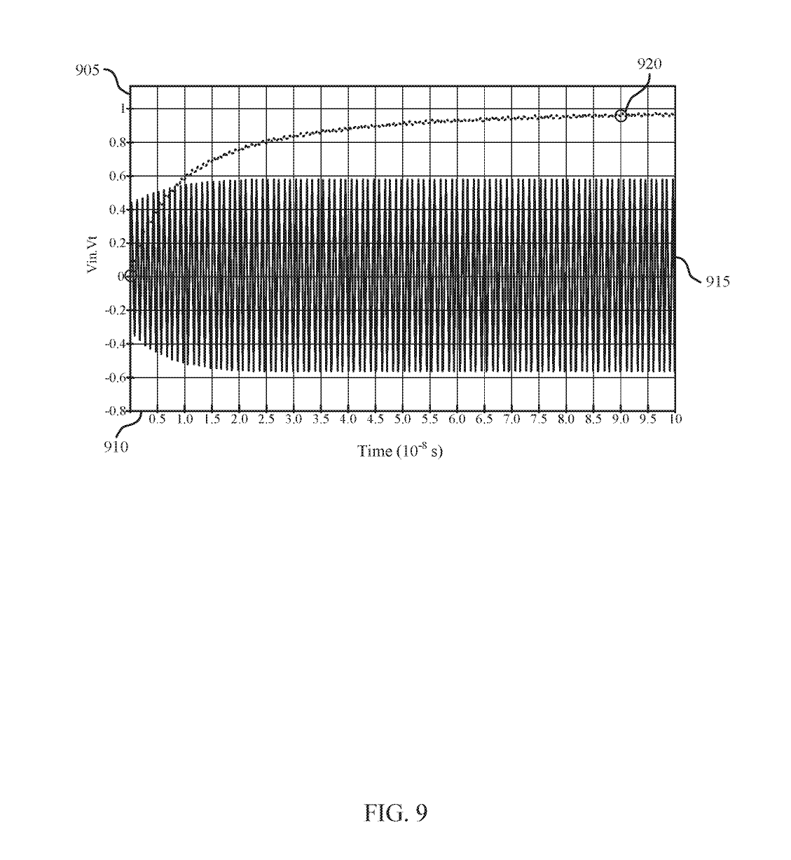

FIG. 9 illustrates an example of simulation results of a circuit that supports harvesting wireless frequencies and converting them, to usable power in accordance with aspects of the present disclosure. FIG. 9 shows a vertical axis 905, horizontal axis 910 representing time (with a scale of 10⁻⁸ seconds), signal input 915, and voltage output 920.

As illustrated, simulation results indicate that a voltage amplifier (e.g., voltage double circuit 805) is able to achieve a voltage output 920 of 0.95 v for signal input 915 of 0 dBrn. By using a matching network, the circuit may reach an output level of 2.0 v.

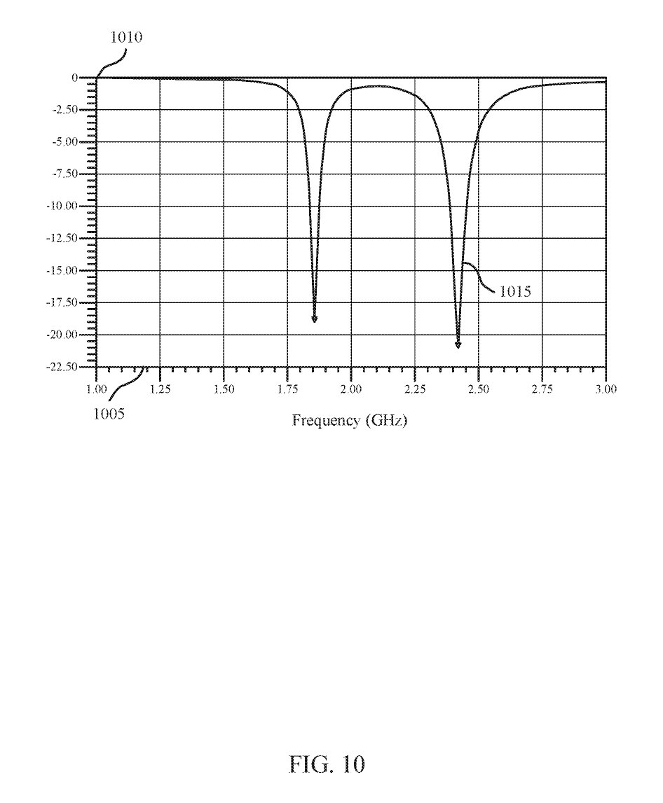

FIG. 10 illustrates an example of a return loss chart of a circuit that supports harvesting wireless frequencies and converting them to usable power in accordance with aspects of the present disclosure. FIG. 10 snows a horizontal axis 1005 representing frequency (in GHz), vertical axis 1010 representing return loss (in dB), and return loss curve 1015.

As illustrated in the return loss chart, a circuit may be matched at both 1.86 GHz and 2.42 GHz with a more optimized return loss value.

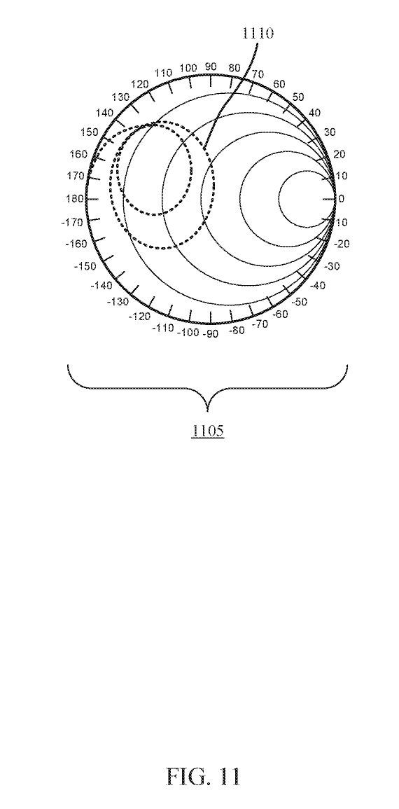

FIG. 11 illustrates an example of a Smith, chart 1105 of a circuit, that supports harvesting wireless frequencies and converting them to usable power in accordance with aspects of the present disclosure.

Smith chart 1105 may include impedance curve 1110. As illustrated in the Smith chart 1105, a circuit may be matched at 1.86 GHz and 2.42 GHz with a more optimized return loss value.

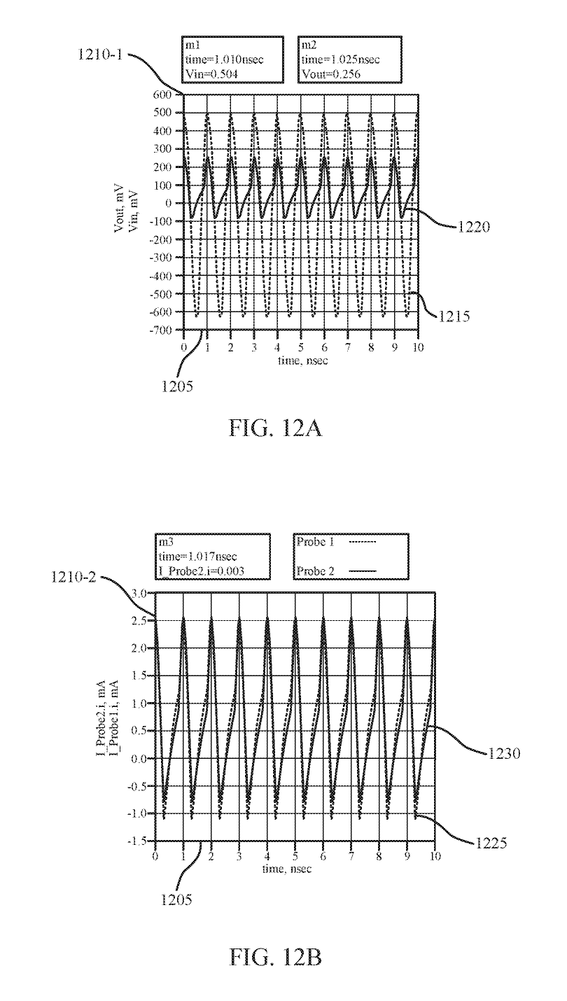

FIGS. 12A and 12B illustrate an example of a forward voltage drop at less than 1 mA. FIG. 12 shows a horizontal axis 1205 representing time (in nanoseconds), vertical axis 1210 (1210-1, in mV, and 1210-2, in mA), input voltage 1215, output voltage 1220, first probe 1225, and second probe 1230.

FIG. 12A represents an example the measured electrical current at the voltage input and the voltage output. FIG. 12B represents an example of a measured electrical current at a first probe and a second probe. As illustrated, a diode may have a forward voltage drop of 0.15 v for an input current of less than 1 mA without optimization.

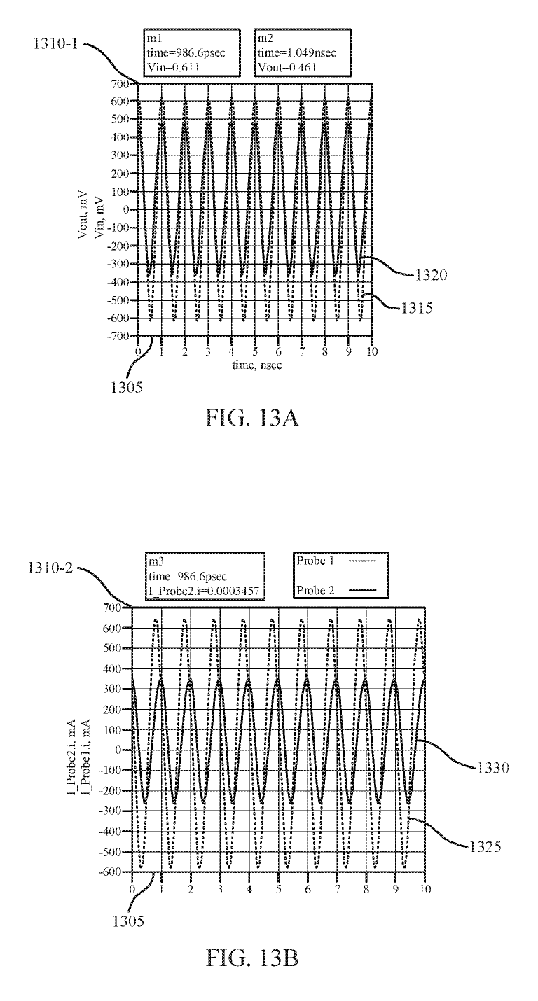

FIGS. 13A and 13B illustrate an example of a forward voltage drop at greater than 1 mA. FIG. 13 shows horizontal axis 1305 representing time (in nanoseconds), vertical axis 1310 (1310-1, in mV, and 1310-2, in mA) input voltage 1315, output voltage 1320, first probe 1325, and second probe 1330.

FIG. 13A represents an example the measured electrical current at the voltage input and the voltage output. FIG. 13B represents an example of a measured electrical current at a first probe and a second probe. In some embodiments, the diode has a forward voltage drop of 0.25 V or more for an input current greater than 1.0 mA.

For energy harvesting applications, current may be very low (just a few mA), generally making a low voltage drop diode suitable for such applications. RF energy harvesting may become usable with customizations and optimization as the signal and power received and generated is greater.

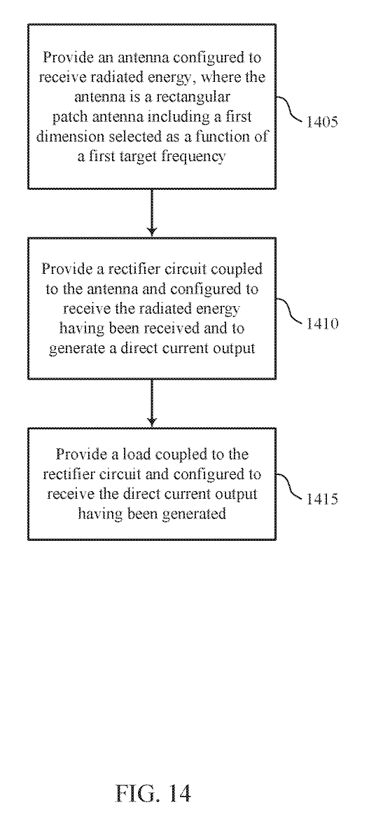

FIG. 14 illustrates an example of a process performed by a manufacturing system for harvesting wireless frequencies and converting them to usable power in accordance with aspects of the present disclosure. In some examples, a manufacturing system may execute a set of codes to control functional elements of the manufacturing system to perform, the described functions. Additionally or alternatively, a manufacturing system may use special-purpose hardware. These operations may be performed according to the methods and processes described in accordance with aspects of the present disclosure. For example, the operations may be composed of various substeps, or may be performed in conjunction with other operations described herein.

At block 1405 the manufacturing system may provide an antenna configured to receive radiated energy, wherein the antenna is a rectangular patch antenna comprising a first dimension selected as a function of a first target frequency. In certain examples, aspects of the described operations may be performed by antenna 110, 320, 405, 505, and 610 as described with reference to FIGS. 1, 3, 4, 5, and 6.

At block 1410 the manufacturing system may provide a rectifier circuit coupled to the antenna and configured to receive the radiated energy having been received and to generate a direct current output. In certain examples, aspects of the described operations may be performed by rectifier 125, 220, 315, and 705 as described with reference to FIGS. 1, 2, 3, and 7.

At block 1415 the manufacturing system may provide a load coupled to the rectifier circuit and configured to receive the direct current output having been generated. In certain examples, aspects of the described operations may be performed by load 150, 250, and 635 as described with reference to FIGS. 1, 2, and 6.

Some of the functional units described in this specification have been labeled as modules, or components, to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. An energy harvesting system, comprising:
an antenna configured to receive radiated energy, wherein the antenna is a rectangular patch antenna comprising a first dimension selected as a function of a first target frequency;
a rectifier circuit coupled to the antenna and configured to receive the radiated energy having been received and to generate a direct current output; and
a load coupled to the rectifier circuit and configured to receive the direct current output having been generated.

2. The energy harvesting system of claim 1, further comprising:
a matching circuit interposed between the antenna and the rectifier and configured to impedance match the antenna to the rectifier circuit.

3. The energy harvesting system of claim 1, further comprising:
a voltage multiplier interposed between the antenna and the rectifier and configured to increase the voltage of the radiated energy.

4. The energy harvesting system of claim 1, wherein:
said antenna configured to receive radiated energy, wherein said antenna is said rectangular patch antenna comprising a second dimension selected as a function of a second target frequency.

5. The energy harvesting system of claim 1, wherein:
said antenna configured to receive radiated energy, wherein said antenna is said rectangular patch antenna comprising feed point comprising a feed point location selected as a function of said first target frequency and said target frequency.

6. The energy harvesting system of claim 1, further comprising:
a printed circuit board; and
wherein said, antenna configured, to receive radiated energy, wherein said antenna is a patch antenna juxtaposed with the printed circuit board.

7. The energy harvesting system of claim 6, further comprising:
a ground plane juxtaposed with said printed circuit board opposite from said antenna, whereby said printed circuit board is interposed between said antenna and said ground plane.

8. The energy harvesting system of claim 1, wherein:
said load comprising an energy storage device configured to store energy from said direct current output.

9. A method of providing a system for energy harvesting, comprising:
providing an antenna configured to receive radiated energy, wherein the antenna is a rectangular patch antenna comprising a first dimension selected as a function of a first target frequency;
providing a rectifier circuit coupled to the antenna and configured to receive the radiated energy having been received and to generate a direct current output; and
providing a load coupled to the rectifier circuit and configured to receive the direct current output having been generated.

10. The method of claim 9, further comprising:
providing a matching circuit interposed between the antenna and the rectifier and configured to impedance match the antenna to the rectifier circuit.

11. The method of claim 9, further comprising:
providing a voltage multiplier interposed between the antenna and the rectifier and configured to increase the voltage of the radiated energy.

12. The method of claim 9, wherein:
said antenna configured to receive radiated energy, wherein said antenna is said rectangular patch antenna comprising a second dimension selected as a function of a second target frequency.

13. The method of claim 9, wherein:
said antenna configured to receive radiated energy, wherein said antenna is said rectangular patch antenna comprising feed point comprising a feed point location selected as a function of said first target frequency and said target frequency.

14. The method of claim 9, further comprising:
providing a printed circuit board; and
wherein said antenna configured to receive radiated energy, wherein said antenna is a patch antenna juxtaposed with the printed circuit board.

15. The method of claim 14, further comprising:
providing a ground plane juxtaposed with said printed circuit board opposite from said antenna, whereby said printed circuit board is interposed between said antenna and said ground plane.

16. The method of claim 9, wherein:
said load comprising an energy storage device configured to store energy from said direct current output.

17. A method for energy harvesting, comprising:
using an antenna configured to receive radiated energy, wherein the antenna is a rectangular patch antenna comprising a first dimension selected as a function of a first target frequency;
using a rectifier circuit coupled to the antenna and configured to receive the radiated energy having been received and to generate a direct current output; and
using a load coupled to the rectifier circuit and configured to receive the direct current output having been generated.

18. The method of claim 17, further comprising:
using a matching circuit interposed between the antenna and the rectifier and configured to impedance match the antenna to the rectifier circuit.

19. The method of claim 17, further comprising:
using a voltage multiplier interposed between the antenna and the rectifier and configured to increase the voltage of the radiated energy.

20. The method of claim 17, wherein:
said antenna configured to receive radiated energy, wherein said antenna is said rectangular patch antenna comprising a second dimension selected as a function of a second target frequency.

21. The method of claim 17, wherein:
said antenna configured to receive radiated energy, wherein said antenna is said rectangular patch antenna comprising feed point comprising a feed point location selected as a function of said first target frequency and said target frequency.

22. The method of claim 17, further comprising:
using a printed circuit board; and
wherein said antenna configured to receive radiated energy, wherein said antenna is a patch antenna juxtaposed with the printed circuit board.

23. The method of claim 22, further comprising:
using a ground plane juxtaposed with said printed circuit board opposite from said antenna, whereby said printed circuit board is interposed between said antenna and said ground plane.

24. The method of claim 17, wherein:
said load comprising an energy storage device configured to store energy from said direct current output.
